(19) United States
(12) Patent Application Publication
(10) Pub. No.: US 2026/0139760 A1
(43) Pub. Date: May 21, 2026

(54) INDICATOR DEVICE AND METHOD OF USING THE SAME

(71) Applicant: Max-Air Technology, Inc., Wentzville, MO (US)

(72) Inventors: Bruce Penning, Clayton, MO (US); Adrian Penning, Vereeniging (ZA)

(21) Appl. No.: 19/367,971

(22) Filed: Oct. 24, 2025

Related U.S. Application Data
(60) Provisional application No. 63/722,920, filed on Nov. 20, 2024.

(51) Int. Cl. F16K 37/00

(52) U.S. Cl. CPC F16K 37/0083

(57) ABSTRACT

A device to indicate the operational, electrical, and/or functional status and position of a valve, the device comprising: an enclosure assembly; a lid assembly removably securable to the enclosure assembly; an electronics module removably positioned between the enclosure assembly and the lid assembly; and a beacon assembly removably securable to the lid assembly, wherein the beacon assembly includes a beacon; wherein the electronics assembly includes a processor, at least one sensor and at least one switch monitoring the operational, electrical, and/or functional status and position of the valve, and a plurality of light emitting diodes; and wherein the processor is configured to monitor the at least one sensor and the at least one switch to instruct one or more of the plurality of light emitting diodes to illuminate one or more portions of the beacon to indicate the operational, electrical, and/or functional status and position of the valve.

### CROSS REFERENCE TO RELATED APPLICATIONS

The present application claims the priority benefit of U.S. Provisional Patent App. Ser. No. 63/722,920, filed November 20, 2024, which is incorporated herein by reference in its entirety.

### BACKGROUND

Oil refineries, plastic processing plants, and food production plants, to name a few, rely on tens of thousands of actuated valves that need to operate without failure under extreme conditions of heat, pressure, corrosion, and abrasion. Currently, there is no cost-effective way to monitor the health of these assemblies in real time. When these valves fail it often costs hundreds of thousands of dollars a day in costs associated with downtime. When these valves fail, they can also lead to hazardous situations such as refinery fires. Current industry solution to these issues is to remove every valve during an outage, which occur every 1-3 years, for inspection and repair. Often times, this inspection is not needed as the outage is often caused by a select few of the valves. While control valves have the ability to be constantly monitored, this solution is too expensive for most.

The present disclosure relates to indicator devices for use with explosion-proof enclosures which indicate operational, electrical, and/or functional status and position of a related valve or device. Under some circumstances, valves or devices may be damaged due to corrosive or abrasive fluids or gasses passing through them or corrosion in the atmosphere, thus rendering the valve or device faulty or damaged. Currently, there are no devices or methods of alerting a user that damage has occurred that could affect the valve or device’s ability to perform. As a result, in some instances, the valve or device may continue to operate without maintenance under unsafe or faulty conditions which may lead to further damage to the internal valves or devices, as well as damage to any downstream equipment connected to the internal valves or devices.

Therefore, there is a need in the art for an indicator device and method of using the same which can alert operators to the operational, electrical, and/or functional status and position of a related valve or device.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 shows a perspective view of a Prior Art Automated Valve Assembly;

FIG. 2 shows a perspective view of a solid-state indicator device of the present disclosure including a switchbox and an integrated solenoid;

FIG. 3 shows a partially exploded view of the solid-state indicator device of FIG. 2;

FIG. 4 shows an exploded view of a beacon assembly of the solid-state indicator device of FIG. 2;

FIG. 5 shows an exploded view of a lid assembly of the solid-state indicator device of FIG. 2;

FIG. 6A shows a first perspective view of an electronics module of the solid-state indicator device of FIG. 2;

FIG. 6B shows a second perspective view of the electronics module of FIG. 6A and its interaction with a shaft of the lid assembly of FIG. 5;

FIG. 7 shows an exploded view of an enclosure assembly of the solid-state indicator device of FIG. 2;

FIG. 8 shows a perspective view of the integrated solenoid separated from the switchbox of the solid-state indicator device of FIG. 2;

FIG. 9 shows an exploded view of a solenoid cartridge, a solenoid cartridge housing, a manual override housing, a solenoid end cap, and related components of the integrated solenoid of FIG. 8; and

FIG. 10 shows an exploded view of a solenoid valve assembly and related components of the integrated solenoid of FIG. 8.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

The present disclosure generally relates to an indicator device and method of using the same that allows for a technician to externally view Light-emitting diode (LED) lights that are positioned inside a non-opaque enclosure while still complying with requirements for electrical equipment used in an explosive gas or dust atmosphere. In one or more versions, illuminated valve or device position indicators will provide status indicators, such as that the assembly is functioning properly or that the assembly is malfunctioning and service in required, via colored LED lights. Such indicator devices and methods of using the same allow a technician to confirm locally that the valve or device is functionally properly from a control room/electrical perspective.

Current solutions for use in explosive atmospheres can only offer mechanical visual position indication leaving the technician blind to operational, electrical, and/or functional status. In one or more versions, additional sensors inside the indicator device may measure various parameters such as air pressure, vibration, and speed of operation. Then, via an artificial intelligence model and a processor, illuminated LED’s which are visible externally can alert the technician of the status of the valve or device. In one or more versions, the LED’s and electronics of the indicator device may be powered by combining power harvesting off the existing electrical circuits and a battery. In one or more versions, a Bluetooth ® or other wireless communication system may also allow the technician to gain additional information on the health of the valve or device as well as specifications of the valve or device as installed by the provider of the equipment. In one or more versions, the indicator device and method of using the same of the present disclosure may allow the technician to safely plan maintenance on a valve or device, preventing costly downtime and/or a hazardous situation which could threaten lives or injury to personnel.

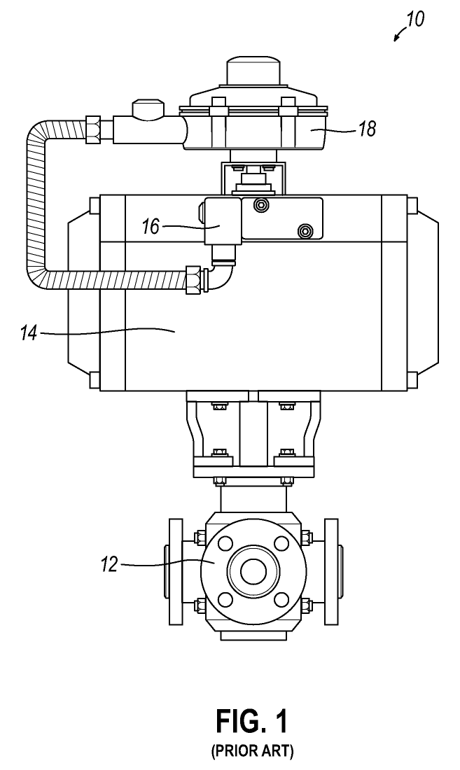

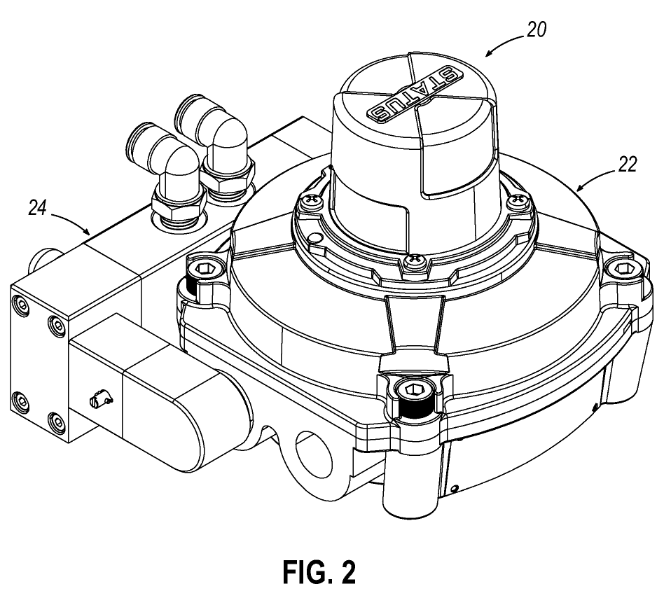

FIG. 1 shows a prior art automated valve assembly 10. In one or more versions, assembly 10 includes a process valve 12, a pneumatic actuator 14, a solenoid 16, and a switchbox 18. Process valve 12 may control the media flowing in the pipeline to which assembly 10 is secured to. Pneumatic actuator 14 may drive process valve 12 into its required position for use. Solenoid 16 may direct pneumatic air electrically to pneumatic actuator 14 to open and close process valve 12. Switchbox 18 may monitor a position of process valve 12. In one or more versions, prior art switchbox 18 and solenoid 16 may be replaced with a solid-state indicator device 20 as shown in FIG. 2.

As shown in FIG. 2, versions of indicator device 20 will include both a switchbox 22 and an integrated solenoid 24. In yet other versions, indicator device 20 will include only switchbox 22, and will work with existing solenoids, such as solenoid 16, to control a valve assembly.

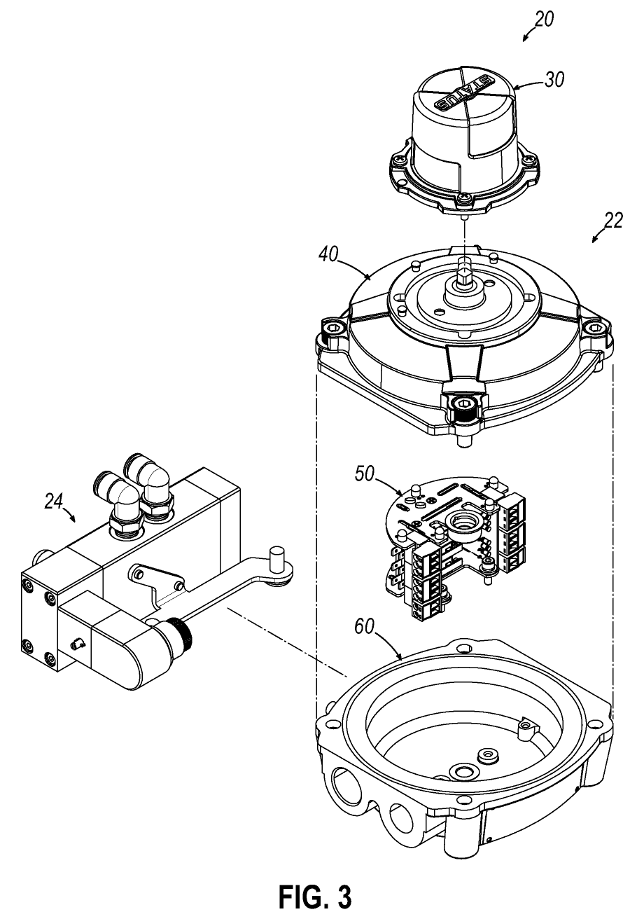

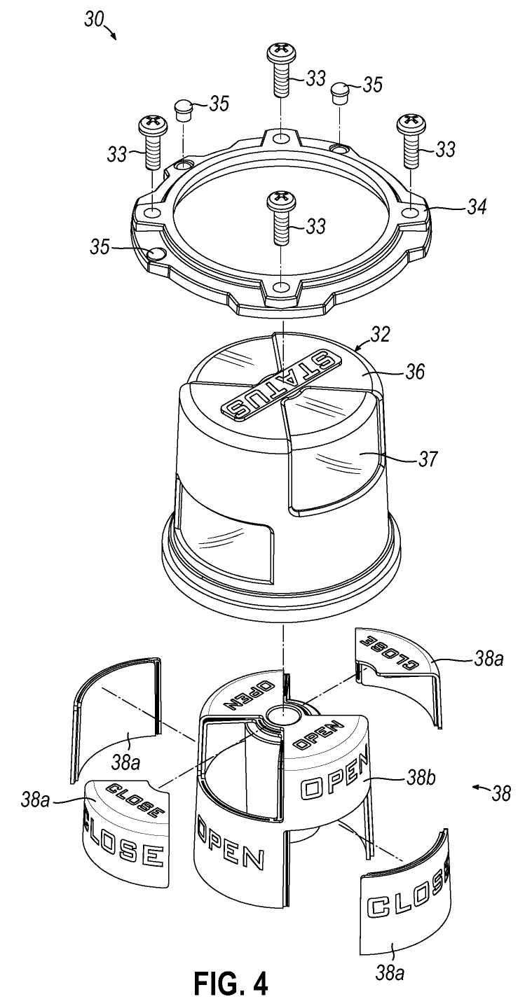

A partially exploded view of indicator device 20 is shown in FIG. 3. Switchbox 22 generally includes a beacon assembly 30, a lid assembly 40, electronics module 50, and an enclosure assembly 60. An exploded view of beacon assembly 30 is shown in FIG. 4. Beacon assembly 30 may include a beacon 32 and a beacon ring 34. Beacon ring 34 may secure beacon 32 to a lid 42 of lid assembly 40 through beacon ring mounting screws 33. Beacon light pipes 35 are secured within beacon ring 34 and work in conjunction with lid light pipes 46 of lid assembly 40 and LED’s 52 of electronic module 50 to showcase light through indicator device 20. Beacon 32 further includes an outer mask 36 attached to an outer clear shell 37 which covers a portion of an inner beacon shell 38. Inner beacon shell 38 includes a plurality of CLOSED parts 38A and a plurality of OPEN parts 38B. Indicator device 20 is designed such that when a valve or device, such as process valve 12, is closed, only CLOSED parts 38a will be visible and when a valve or device, such as process valve 12, is open, only OPEN parts 38b will be visible.

In one or more versions, CLOSED parts 38a may be made of red plastic and OPEN parts 3Bb may be made of green plastic to ensure when illuminated, that a green or red color is clearly identifiable from a distance. In one or more versions, CLOSED parts 38a may be sonic welded to OPEN parts 38b to form inner beacon shell 38. Inner beacon shell 38 may be connected to and rotated on a shaft 43 of shaft assembly 44 which may be attached to an external actuated valve assembly, such as process valve 12. Prior art solutions, such as switchbox 18, typically print or use stickers on their inner beacon to show the position colors and may be less effective than inner beacon shell 38 for visibility from a distance.

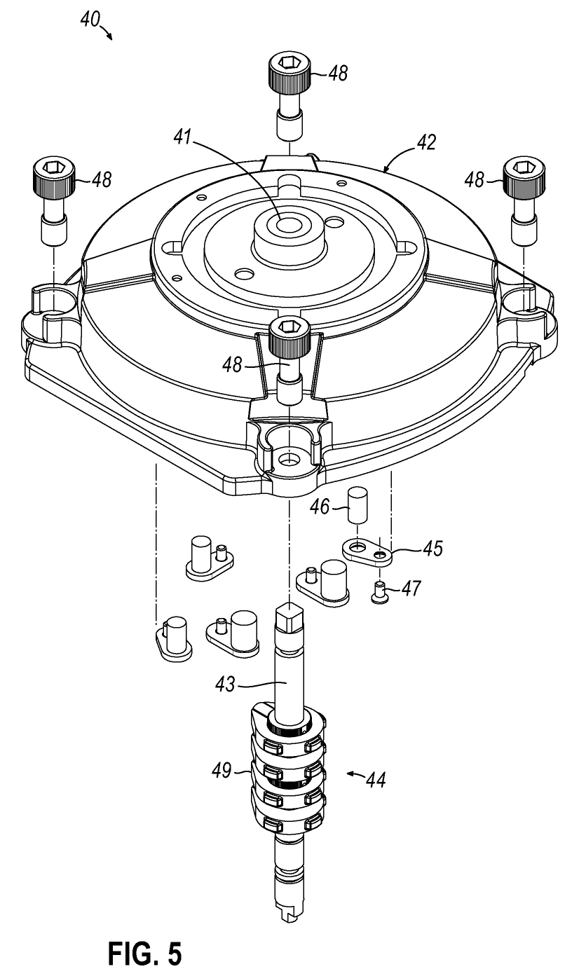

An exploded view of lid assembly 40 is shown in FIG. 5. Lid assembly 40 may include lid 42 and shaft assembly 44. A bearing 41 within lid 42 allows shaft 43 of assembly 44 to pass through lid 42. Lid light pipes 46 are integrated within lid assembly 40 to work with beacon light pipes 35 and LED’s 52 of electronic module 50 to showcase light through indicator device 20. Lid light pipes 46 are held in position by light pipe keepers 45 and keeper mounting screws 47. Lid 42 may be secured to enclosure 62 of enclosure assembly 60 through lid mounting screws 48. Shaft assembly 44 may include shaft 43 and a plurality of cams 49. Once indicator device 20, with or without integrated solenoid 24, is fitted to an automated valve, such as process valve 12, the plurality of cams 49 may be set to correctly indicated open and closed positions of the automated valve.

In one or more versions, lid 42 may be cast in aluminum or stainless steel while shaft 43 and bearing 41 may have tolerances and dimensions that meet standard requirements for electrical devices used in an explosive atmosphere. Lid light pipes 46 may be made out of glass and may be fitted into holes in lid 42 while being held in place by light pipe keepers 45 and keeper mounting screws 47 and/or an adhesive. In one or more versions, the method of fixing lid light pipes 46 may meet standard requirements for electrical devices used in an explosive atmosphere.

Lid light pipes 46 may be positioned directly above LED's 52 of electronic module 50 so they are visible from outside indicator device 20. Although not shown, in one or more versions, a foam cutout may be adhered inside lid 42 to ensure only the correct lid light pipe 46 passes light from a particular LED 52. The foam cutout, if present, would have space for each lid light pipe 46, such that if one lid light pipe 46 is lit up, the foam will dampen the path of the light such that the light will only travel to the correct LED 52.

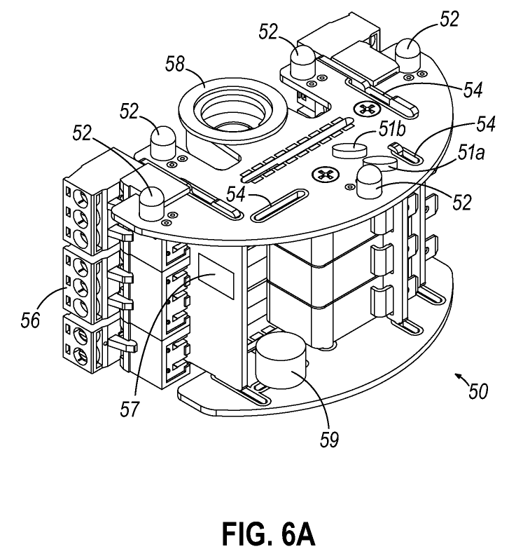

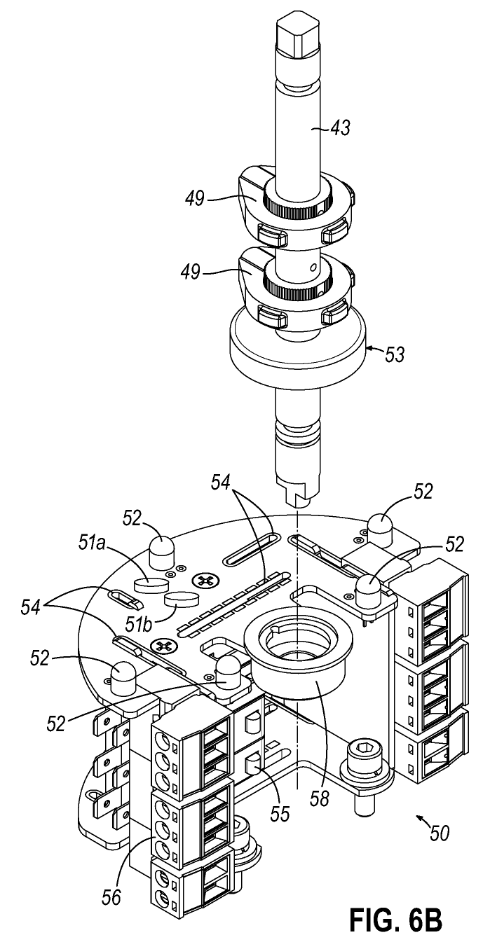

Electronics module 50 is shown in FIGS. 6A and 6B. Electronics module 50 may be fitted with a plurality of switches 54 of different types. In one or more versions, electronics module 50 includes up to four switches 54 of different types. Electronics module 50 houses a processor 57 that may be connected to one or more sensors, such as sensor 61, that may control LED's 52 to indicate aspects of a valve assembly such as, valve position, switch status, and/or solenoid status. In one or more versions, one of the one or more sensors, such as sensor 61, may monitor and indicate power being utilized by solenoid (either integrated solenoid 24 or a non-integrated solenoid, such as solenoid 16) that controls a position of valve 12. In one or more versions, one of the one or more sensors, such as sensor 61, may monitor and indicate an end-of-stroke position of valve 12. Such positions may include open, closed, and mid-position. In one or more versions, one of the one or more sensors, such as sensor 61, may monitor and indicate the condition of the overall assembly, wherein the one of the one or more sensors, such as sensor 61, may include one or more of a giant magnetoresistance (GMR) sensor, an accelerometer, a temperature sensor, and/or an air pressure sensor.

Processor 57 may also analyze data from the one or more sensors, such as sensor 61, switches 54, and solenoid (either integrated solenoid 24 or a non-integrated solenoid, such as solenoid 16) to determine working conditions of the valve assembly to be able to illuminate the correct LED 52 accordingly. Electronics module 50 may further include wiring terminals 56 to connect indicator device 20, with or without integrated solenoid 24, to a host control system via electrical wiring passing through conduit entries 65 in enclosure assembly 60. A bearing 58 may be present to allow for shaft 43 to pass through. Electronics module 50 may additionally include a power source, such as a battery 59. In one or more versions, the power source, such as battery 59, may include electronics such as charging circuits (not shown) that allow for electronics module 50 to scavenge power from existing switch circuits.

In one or more versions, while valve 12 is in either a closed or open position, power may be passed through the existing switch circuit from the host system to indicate remotely its position. In one or more versions, the host system can be considered the overall control system of the plant/unit in which valve 12 is operating in. In these instances, power may be scavenged to power electronics module 50, which will keep the power source, such as battery 59, within electronics module 50 charged. In one or more versions, available power may also be scavenged off power being sent to solenoid 16 or 24 as a backup to keep the power source, such as battery 59, charged. As valve 12 switches between positions, power is no longer available from the existing switch circuits. During these times, electronics module 50 may draw power from the power source, such as battery 59, until either the closed or open position is reached.

In one or more versions, two LED's 52 may illuminate beacon 32 to enhance visibility of beacon 32, while three LED’s 52 may be used to show a status of switches 54, a status of solenoid (either integrated solenoid 24 or a non-integrated solenoid, such as solenoid 16), and an AI driven status alert of working condition of the overall assembly, such as automated valve assembly 10. An example of the different statuses that could be indicated by LED’s 52 include above average working conditions, average working conditions, and failing. In one or more versions, the thresholds for these statuses can be programmed into processor 57, and the thresholds may be dependent upon the overall assembly that indicator device 20 may be connected to. The different statuses that could be indicated by LED’s 52 may be determined by processor 57 of electronics module 50 as it monitors travel time (time to switch valve 12 between open and closed).

In one or more versions, switches 54 may be either mechanical switches, reed-type switches, or inductive-type switches that may be used to indicate the position (typically either open, closed, or transitioning between open and closed) of valve 12. Switches 54 may be activated by cams 49 on shaft 43 which may be driven by valve 12. The operator of assembly 10 can pre-set a position of cams 49 when setting up indicator device 20. Switches 54 may be wired to an external control system, such as a programmable logic controller (not shown). Processor 57 within electronics module 50 may also read positions of switches 54 and use this information to illuminate LED’s 52 as needed.

Electrical coils of solenoid cartridge 70 (discussed below) may be wired to the host system which powers the coils to either drive valve 12 into an open or closed position. Processor 57 of electronics module 50 may monitor these wired connections to know when LED’s 52 need to be illuminated. Processor 57 of electronics module 50 may also monitor the amount of power drawn by the electrical coils of solenoid cartridge 70, as this may be an indication of whether the electrical coils are working correctly.

In one or more versions, electronics module 50 may further contain a first push button 51a, and a second push button 51b. On commissioning the actuated valve assembly 10, push buttons 51a and 51b may be utilized by an operator to record open and closing times of valve 12, which may be used as a baseline for processor 57 of electronics module 50 to measure against. In one or more versions, the commissioning sequence may be that push button 51a is pressed to enter a recording mode, push button 51b may be pressed once the open and closed positions of valve 12 are achieved, then push button 51a may be pressed again to return to operating mode.

In one or more versions, electronics module 50 may also contain a giant magnetoresistance (GMR) sensor 55, which may be activated by a ring magnet 53 attached to shaft 43. GMR sensor 55 may continuously measure an exact position of valve 12. The signal created may be read by processor 57 of electronics module 50 and the signal may then be used to create and position an output signal which may be fed to another circuit (not shown) within electronics module 50. This circuit can then be connected to the host system to produce a varying current signal proportional to a position of valve 12. Processor 57 of electronics module 50 may also monitor the position of valve 12 and may use abnormalities in movement speed and acceleration in movements of valve 12 to determine a status of valve 12.

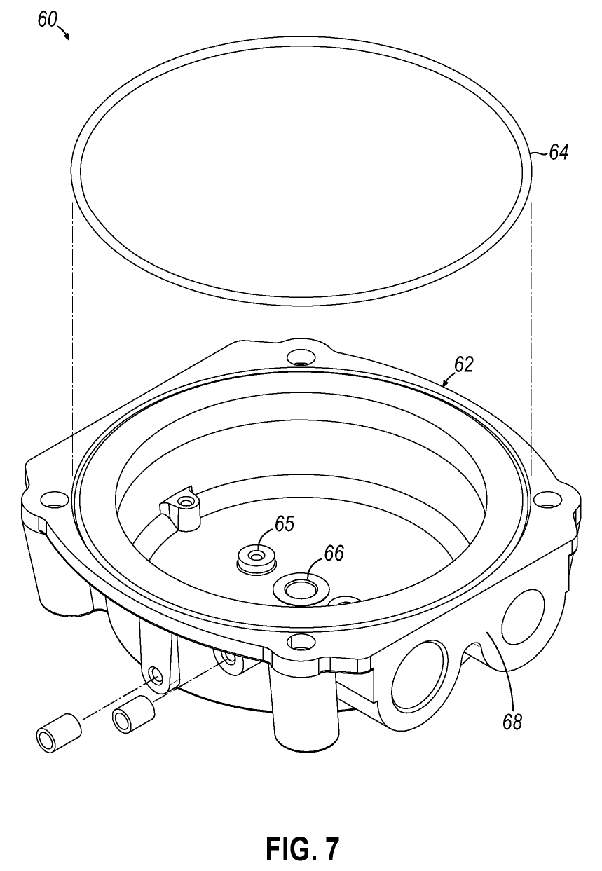

An exploded view of enclosure assembly 60 is shown in FIG. 7. Enclosure assembly 60 may include enclosure 62 and lid O-ring 64. In one or more versions, enclosure 60 may be cast in either Aluminum or stainless steel while meeting standard requirements for electrical devices used in an explosive atmosphere. Threaded conduit entries 65 may be machined into enclosure 62 which may be utilized for passing wiring to electronics module 50 housed within enclosure 62. A bearing 66 may be machined into enclosure 62 for shaft 43 to pass through. Threaded conduit entries 65 and bearing 66 also may meet standard requirements for electrical devices used in an explosive atmosphere. O-ring 64 may prevent liquid or dust ingress into enclosure 62, protecting electronics module 50 housed within enclosure 62. Enclosure 62 may additionally include solenoid conduit entries 68 which may be machined into enclosure 62 to meet a press fit tolerance which may allow for the integration of a solenoid valve assembly of either integrated solenoid 24 or a non-integrated solenoid, such as solenoid 16. Solenoid conduit entries 68 may also meet standard requirements for electrical devices used in an explosive atmosphere.

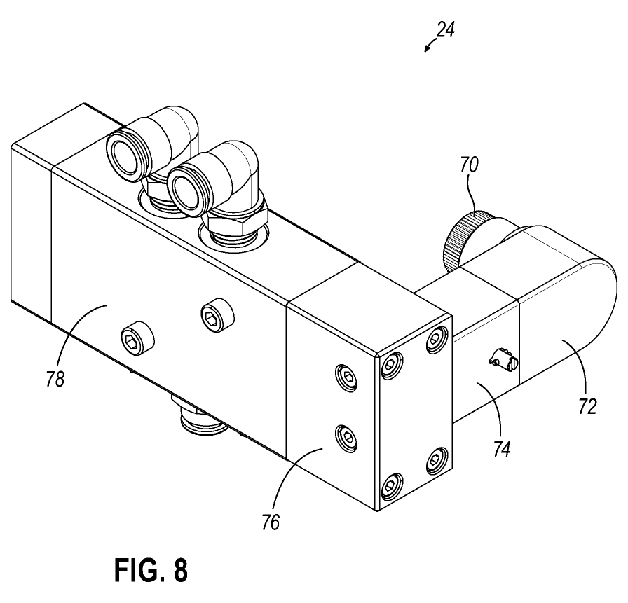

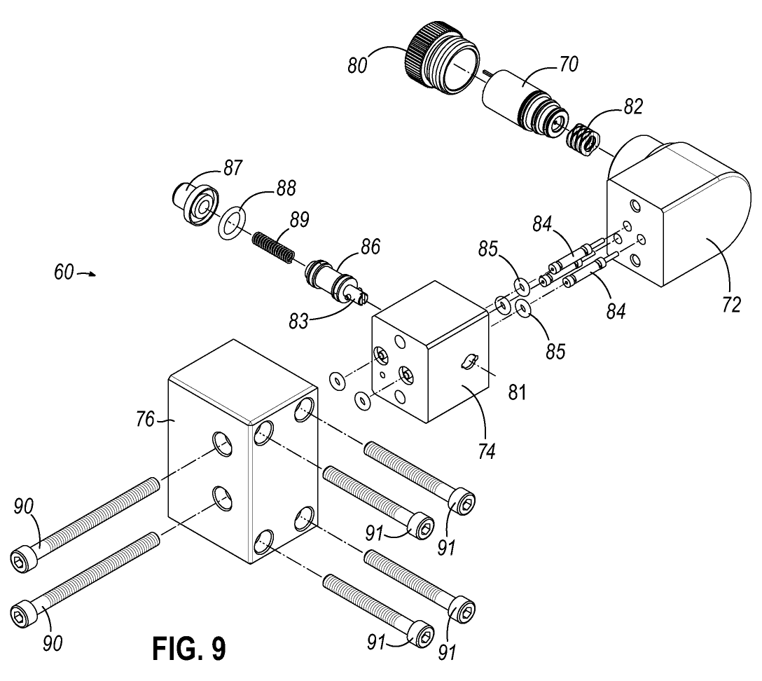

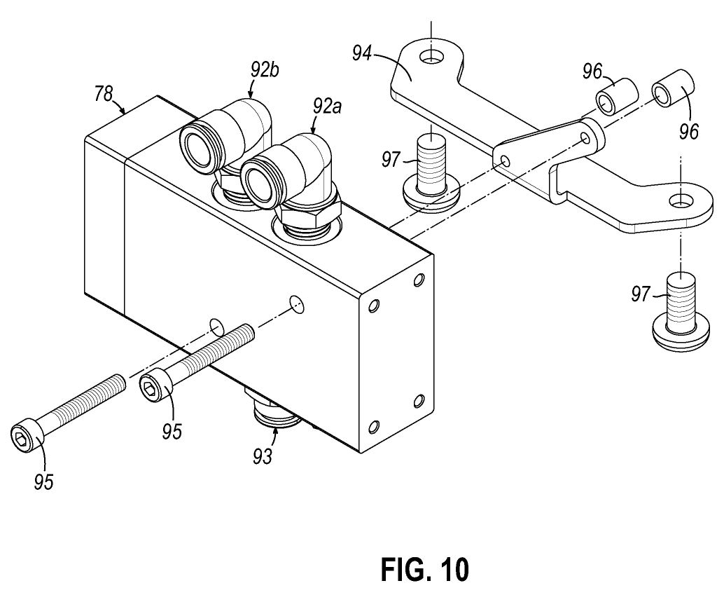

FIG. 8 shows integrated solenoid 24 separated from switchbox 22. Integrated solenoid 24 may include a solenoid cartridge 70, a solenoid cartridge housing 72, a manual override housing 74, a solenoid end cap 76, and a solenoid valve assembly 78. FIG. 9 shows an exploded view of solenoid valve assembly 78 and related components, while FIG. 10 shows an exploded view of solenoid cartridge 70, solenoid cartridge housing 72, manual override housing 74, solenoid end cap 76 and related components.

As shown in FIG. 9, a cartridge mounting cap 80 may be located on an exterior facing surface of solenoid cartridge 70 and a cartridge wave spring removal aid 82 may be located between solenoid cartridge 70 and solenoid cartridge housing 72. A plurality of flame arresters 84 may be located between solenoid cartridge housing 72 and manual override housing 74, with the plurality of flame arresters 84 being press fit into the solenoid cartridge housing 72 and manual override housing 74 and sealed by O-rings 85. An override spool assembly 86 may be held in place within manual override housing 74 by an override spring cup 87, an O-ring 88, and an override return spring 89. Cartridge mounting bolts 90 may secure solenoid cartridge housing 72, manual override housing 74, and solenoid end cap 76 together, while solenoid end cap mounting bolts 91 may secure solenoid end cap 76 to solenoid valve assembly 78.

As shown in FIG. 10, solenoid valve assembly 78 may include solenoid outlet ports 92a and 92b, as well as a solenoid supply port 93. Integrated solenoid 24 may be secured to switchbox 22 through a solenoid mounting bracket 94, which may provide two points of attachment to switchbox 22, along a bottom of switchbox 22 and along a side of switchbox 22. Side solenoid mounting bolts 95 and side solenoid mounting spacers 96 may secure solenoid 24 along the side of switchbox 22 while lower mounting bolts 97 may secure solenoid 24 along the bottom of switchbox 22.

In one or more versions, solenoid cartridge 70 may consist of an electrical coil and parts which direct air to and from the solenoid end cap 76. Solenoid cartridge 70 may be held in place by solenoid mounting cap 80 and cartridge wave spring removal aid 82 may be placed at the tip of solenoid cartridge 70 to aid removal when solenoid cartridge 70 needs to be replaced.

The plurality of flame arresters 84 may be press fit into solenoid cartridge housing 72 for the air from solenoid cartridge 70 to pass through to and from the solenoid end cap 76. The plurality of flame arresters 84 may meet standard requirements for devices used in explosive atmospheres. Solenoid cartridge housing 72 may be press fit with solenoid conduit entries 68 in accordance with standards for electrical devices used in explosive atmospheres.

Manual override housing 74 houses a manual override allowing the user to locally operate solenoid valve assembly 78 by bypassing solenoid cartridge 78 via a push button 83 which can be reached through a push button hole 81 in manual override housing 74. Push button 83 may allow for local operation by controlling air pressure in solenoid end cap 76, which shifts a spool in solenoid valve assembly 78. To activate the manual override, an operator may simply depress push button 83. To deactivate, the operator may simply release push button 83, and a spring in solenoid valve assembly 78 may move push button 83 back into a neutral position. In order to lock the manual override, an operator may twist push button 83 ninety degrees, and it may lock in a depressed position. To deactivate, an operator may twist push button 83 back into position and the spring from solenoid valve assembly 78 may push it back into position.

Solenoid end cap 76 may house a piston (not shown) which may be driven by air from the solenoid cartridge 70 or manual override to shift a spool in solenoid valve assembly 78. The spool in solenoid valve assembly 78 may direct air from solenoid supply port 93 to either solenoid outlet ports 92a or 92b to open or close the automated valve assembly, such as process valve 12. The spool in solenoid valve assembly 78 may also allow the air from solenoid outlet ports 92a or 92b to exhaust air to atmosphere. In one or more versions, the opposing end of the spool in solenoid valve assembly 78 may be fitted with override return spring 89 so when solenoid cartridge 70 removes air from the piston it returns to its original position. This ensures that if air or electrical power fails, automated valve assembly 10 can return to a safe position. In one or more versions, spool spring may be replaced by a mirror image of solenoid cartridge housing 72 and solenoid end cap 76 to achieve a fail in place function. In one or more versions, solenoid cartridge 70 may be wired via electronic module 50 to control solenoid 24 while also allowing the processor of electronics module 50 to measure current draw to monitor and report solenoid 24 working status.

### Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A device to indicate the operational, electrical, and/or functional status and position of a valve, the device comprising: an enclosure assembly, a lid assembly removably securable to the enclosure assembly, an electronics module removably positioned between the enclosure assembly and the lid assembly, and a beacon assembly removably securable to the lid assembly, wherein the beacon assembly includes a beacon; wherein the electronics assembly includes a processor, at least one sensor monitoring the operational, electrical, and/or functional status and position of the valve, at least one switch monitoring the operational, electrical, and/or functional status and position of the valve, and a plurality of light emitting diodes, and wherein the processor is configured to monitor the at least one sensor and the at least one switch to instruct one or more of the plurality of light emitting diodes to illuminate one or more portions of the beacon to indicate the operational, electrical, and/or functional status and position of the valve.

### Example 2

The device of Example 1, wherein the enclosure assembly includes an enclosure and a lid O-ring, wherein the enclosure includes one or more threaded conduit entries and a bearing.

### Example 3

The device of Example 2, wherein the lid assembly includes a lid and a shaft assembly, wherein the lid includes a bearing, and wherein the shaft assembly includes a shaft and a plurality of cams.

### Example 4

The device of Example 3, wherein the shaft is configurable to pass through the bearing of the lid and the bearing of the enclosure.

### Example 5

The device of Example 3, wherein the lid assembly further includes a plurality of lid light pipes, a plurality of light pipe keepers, and a plurality of keeper mounting screws; wherein each lid light pipe of the plurality of lid light pipes are held in position within the lid assembly by one of the light pipe keepers of the plurality of light pipe keepers and one of the keeper mounting screws of the plurality of keeper mounting screws; and wherein a lid light pipe of the plurality of lid light pipes are positioned directly above a light emitting diode of the plurality of light emitting diodes such that each light lid pipe is visible from outside the indicator device.

### Example 6

The device of Example 3, wherein the beacon assembly further includes a beacon ring wherein the beacon ring secures the beacon to the lid.

### Example 7

The device of Example 6, wherein the beacon further includes an outer mask securable to an outer clear shell which covers a portion of an inner beacon shell; and wherein the inner beacon shell is securable to and rotatable by the shaft of the shaft assembly.

### Example 8

The device of Example 7, wherein the inner beacon shell includes a plurality of first parts and a plurality of second parts, wherein the plurality of first parts indicate a first status of the valve when illuminated by the plurality of light emitting diodes and the plurality of second parts indicate a second status of the valve when illuminated by the light emitting diodes; and wherein the plurality of second parts are not visible when the valve is in the first status and the plurality of first parts are not visible when the valve is in the second status.

### Example 9

The device of Example 2, further comprising an integrated solenoid wherein wiring terminals of the electronics module pass through the one or more threaded conduit entries of the enclosure to connect the integrated solenoid to the enclosure.

### Example 10

The device of Example 1, wherein the electronics module further includes a power source.

### Example 11

A device to indicate the operational, electrical, and/or functional status and position of a valve within a powered host system, the device comprising: a housing unit; an electronics module removably positioned within the housing unit, wherein the electronics module includes a power source and charging circuitry; and a beacon assembly removably securable to the housing unit, wherein the beacon assembly includes a beacon; wherein the charging circuitry of the electronics module is configured to scavenge power from the powered host system when available in order to power the device and charge the power source, and when power is not available from the powered host system, the power source is configured to power the device; wherein the electronics assembly further includes a processor, at least one sensor monitoring the operational, electrical, and/or functional status and position of the valve, at least one switch monitoring the operational, electrical, and/or functional status and position of the valve, and a plurality of light emitting diodes; and wherein the processor is configured to monitor the at least one sensor and the at least one switch to instruct one or more of the plurality of light emitting diodes to illuminate one or more portions of the beacon to indicate the operational, electrical, and/or functional status and position of the valve

### Example 12

The device of Example 11, wherein the housing unit includes an enclosure assembly and a lid assembly removable securable to the enclosure assembly.

### Example 13

The device of Example 12, wherein the enclosure assembly includes an enclosure and a lid O-ring, wherein the enclosure includes one or more threaded conduit entries and a bearing.

### Example 14

The device of Example 13, wherein the lid assembly includes a lid and a shaft assembly, wherein the lid includes a bearing, and wherein the shaft assembly includes a shaft and a plurality of cams.

### Example 15

The device of Example 14, wherein the shaft is configurable to pass through the bearing of the lid and the bearing of the enclosure.

### Example 16

The device of Example 14, wherein the lid assembly further includes a plurality of lid light pipes, a plurality of light pipe keepers, and a plurality of keeper mounting screws; wherein each lid light pipe of the plurality of lid light pipes are held in position within the lid assembly by one of the light pipe keepers of the plurality of light pipe keepers and one of the keeper mounting screws of the plurality of keeper mounting screws; and wherein a lid light pipe of the plurality of lid light pipes are positioned directly above a light emitting diode of the plurality of light emitting diodes such that each light lid pipe is visible from outside the indicator device.

### Example 17

The device of Example 11, wherein the beacon further includes an outer mask securable to an outer clear shell which covers a portion of an inner beacon shell; and wherein the inner beacon shell is securable to and rotatable by the shaft of the shaft assembly.

### Example 18

The device of Example 17, wherein the inner beacon shell includes a plurality of first parts and a plurality of second parts, wherein the plurality of first parts indicate a first status of the valve when illuminated by the plurality of light emitting diodes and the plurality of second parts indicate a second status of the valve when illuminated by the light emitting diodes; and wherein the plurality of second parts are not visible when the valve is in the first status and the plurality of first parts are not visible when the valve is in the second status.

### Example 19

The device of Example 13, further comprising an integrated solenoid wherein wiring terminals of the electronics module pass through the one or more threaded conduit entries of the enclosure to connect the integrated solenoid to the enclosure.

### Example 20

A method of illuminating an indicator device for monitoring operational, electrical, and/or functional status and position of a valve, the indicator device including: an enclosure assembly; a lid assembly removably securable to the enclosure assembly; an electronics module removably positioned between the enclosure assembly and the lid assembly, the electronics module including a processor, at least one sensor, at least one switch, and a plurality of light emitting diodes; and a beacon assembly removably securable to the lid assembly and including a beacon; the method comprising: monitoring, by the at least one sensor and the at least one switch, the operational, electrical, and/or functional status and position of the valve to create status and position data; analyzing, by the processor, of the status and position data to determine one or more working conditions of the valve; and instructing, by the processor, one or more of the plurality of light emitting diodes to illuminate based on the one or more working conditions of the valve to indicate one or more of the operational, electrical, and/or functional status and position of the valve.

### Miscellaneous

It should be understood that any of the versions of instruments described herein may include various other features in addition to or in lieu of those described above. By way of example only, any of the instruments described herein may also include one or more of the various features disclosed in any of the various references that are incorporated by reference herein. It should also be understood that the teachings herein may be readily applied to any of the instruments described in any of the other references cited herein, such that the teachings herein may be readily combined with the teachings of any of the references cited herein in numerous ways. Moreover, those of ordinary skill in the art will recognize that various teachings herein may be readily applied to electrosurgical instruments, stapling instruments, and other kinds of surgical instruments. Other types of instruments into which the teachings herein may be incorporated will be apparent to those of ordinary skill in the art.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A device to indicate the operational, electrical, and/or functional status and position of a valve, the device comprising:
an enclosure assembly;
a lid assembly removably securable to the enclosure assembly;
an electronics module removably positioned between the enclosure assembly and the lid assembly; and
a beacon assembly removably securable to the lid assembly, wherein the beacon assembly includes a beacon;
wherein the electronics assembly includes a processor, at least one sensor monitoring the operational, electrical, and/or functional status and position of the valve, at least one switch monitoring the operational, electrical, and/or functional status and position of the valve, and a plurality of light emitting diodes; and
wherein the processor is configured to monitor the at least one sensor and the at least one switch to instruct one or more of the plurality of light emitting diodes to illuminate one or more portions of the beacon to indicate the operational, electrical, and/or functional status and position of the valve.

2. The device of claim 1, wherein the enclosure assembly includes an enclosure and a lid O-ring, wherein the enclosure includes one or more threaded conduit entries and a bearing.

3. The device of claim 2, wherein the lid assembly includes a lid and a shaft assembly, wherein the lid includes a bearing, and wherein the shaft assembly includes a shaft and a plurality of cams.

4. The device of claim 3, wherein the shaft is configurable to pass through the bearing of the lid and the bearing of the enclosure.

5. The device of claim 3, wherein the lid assembly further includes a plurality of lid light pipes, a plurality of light pipe keepers, and a plurality of keeper mounting screws; wherein each lid light pipe of the plurality of lid light pipes are held in position within the lid assembly by one of the light pipe keepers of the plurality of light pipe keepers and one of the keeper mounting screws of the plurality of keeper mounting screws; and wherein a lid light pipe of the plurality of lid light pipes are positioned directly above a light emitting diode of the plurality of light emitting diodes such that each light lid pipe is visible from outside the indicator device.

6. The device of claim 3, wherein the beacon assembly further includes a beacon ring wherein the beacon ring secures the beacon to the lid.

7. The device of claim 6, wherein the beacon further includes an outer mask securable to an outer clear shell which covers a portion of an inner beacon shell; and wherein the inner beacon shell is securable to and rotatable by the shaft of the shaft assembly.

8. The device of claim 7, wherein the inner beacon shell includes a plurality of first parts and a plurality of second parts, wherein the plurality of first parts indicate a first status of the valve when illuminated by the plurality of light emitting diodes and the plurality of second parts indicate a second status of the valve when illuminated by the light emitting diodes; and wherein the plurality of second parts are not visible when the valve is in the first status and the plurality of first parts are not visible when the valve is in the second status.

9. The device of claim 2, further comprising an integrated solenoid wherein wiring terminals of the electronics module pass through the one or more threaded conduit entries of the enclosure to connect the integrated solenoid to the enclosure.

10. The device of claim 1, wherein the electronics module further includes a power source.

11. A device to indicate the operational, electrical, and/or functional status and position of a valve within a powered host system, the device comprising:
a housing unit;
an electronics module removably positioned within the housing unit, wherein the electronics module includes a power source and charging circuitry; and
a beacon assembly removably securable to the housing unit, wherein the beacon assembly includes a beacon;
wherein the charging circuitry of the electronics module is configured to scavenge power from the powered host system when available in order to power the device and charge the power source, and when power is not available from the powered host system, the power source is configured to power the device;
wherein the electronics assembly includes a processor, at least one sensor monitoring the operational, electrical, and/or functional status and position of the valve, at least one switch monitoring the operational, electrical, and/or functional status and position of the valve, and a plurality of light emitting diodes; and
wherein the processor is configured to monitor the at least one sensor and the at least one switch to instruct one or more of the plurality of light emitting diodes to illuminate one or more portions of the beacon to indicate the operational, electrical, and/or functional status and position of the valve.

12. The device of claim 11, wherein the housing unit includes an enclosure assembly and a lid assembly removable securable to the enclosure assembly.

13. The device of claim 12, wherein the enclosure assembly includes an enclosure and a lid O-ring, wherein the enclosure includes one or more threaded conduit entries and a bearing.

14. The device of claim 13, wherein the lid assembly includes a lid and a shaft assembly, wherein the lid includes a bearing, and wherein the shaft assembly includes a shaft and a plurality of cams.

15. The device of claim 14, wherein the shaft is configurable to pass through the bearing of the lid and the bearing of the enclosure.

16. The device of claim 14, wherein the lid assembly further includes a plurality of lid light pipes, a plurality of light pipe keepers, and a plurality of keeper mounting screws; wherein each lid light pipe of the plurality of lid light pipes are held in position within the lid assembly by one of the light pipe keepers of the plurality of light pipe keepers and one of the keeper mounting screws of the plurality of keeper mounting screws; and wherein a lid light pipe of the plurality of lid light pipes are positioned directly above a light emitting diode of the plurality of light emitting diodes such that each light lid pipe is visible from outside the indicator device.

17. The device of claim 11, wherein the beacon further includes an outer mask securable to an outer clear shell which covers a portion of an inner beacon shell; and wherein the inner beacon shell is securable to and rotatable by the shaft of the shaft assembly.

18. The device of claim 17, wherein the inner beacon shell includes a plurality of first parts and a plurality of second parts, wherein the plurality of first parts indicate a first status of the valve when illuminated by the plurality of light emitting diodes and the plurality of second parts indicate a second status of the valve when illuminated by the light emitting diodes; and wherein the plurality of second parts are not visible when the valve is in the first status and the plurality of first parts are not visible when the valve is in the second status.

19. The device of claim 13, further comprising an integrated solenoid wherein wiring terminals of the electronics module pass through the one or more threaded conduit entries of the enclosure to connect the integrated solenoid to the enclosure.

20. A method of illuminating an indicator device for monitoring operational, electrical, and/or functional status and position of a valve, the indicator device including: an enclosure assembly; a lid assembly removably securable to the enclosure assembly; an electronics module removably positioned between the enclosure assembly and the lid assembly, the electronics module including a processor, at least one sensor, at least one switch, and a plurality of light emitting diodes; and a beacon assembly removably securable to the lid assembly and including a beacon; the method comprising:
(a) monitoring, by the plurality of sensors and the plurality of switches, the operational, electrical, and/or functional status and position of the valve to create status and position data;
(b) analyzing, by the processor, of the status and position data to determine one or more working conditions of the valve; and
(c) instructing, by the processor, one or more of the plurality of light emitting diodes to illuminate based on the one or more working conditions of the valve to indicate one or more of the operational, electrical, and/or functional status and position of the valve.
